(19) United States
(12) Patent Application Publication
(10) Pub. No.: US 2026/0261071 A1
(43) Pub. Date: Sep. 3, 2026

(54) CONNECTOR AND ELECTRONIC DEVICE

(71) Applicant: HUAWEI TECHNOLOGIES CO., LTD., Shenzhen (CN)

(72) Inventors: Zhongming Zhang, Dongguan (CN); Chenggang Chu, Langfang (CN); Yong Luo, Shenzhen (CN)

(21) Appl. No.: 19/660,599

(22) Filed: Apr. 28, 2026

Related U.S. Application Data
(63) Continuation of application No. PCT/CN2024/128263, filed on Oct. 29, 2024.

(30) Foreign Application Priority Data
Oct. 31, 2023 (CN) 202311435972.9

(51) Int. Cl. H01R 13/52; H01R 4/50; H01R 13/405; H01R 13/502

(52) U.S. Cl. CPC H01R 13/5205; H01R 4/5008; H01R 13/405; H01R 13/502

(57) ABSTRACT

A connector includes a sealing member, a first shell, a second shell, and a rotating member. The sealing member has a through hole for a cable to pass through, and the sealing member is fastened to the first shell. The second shell has an abutting surface that is disposed toward an outer periphery of the sealing member, and the abutting surface is at an included angle with an axis of the through hole. The rotating member is rotatably disposed on the second shell, and the rotating member is connected to the first shell. When the rotating member rotates to a first position, the abutting surface abuts against the outer periphery of the sealing member, so that an inner wall of the through hole fits the cable in a sealed manner.

### CROSS-REFERENCE TO RELATED APPLICATIONS

This application is a continuation of International Application No. PCT/CN2024/128263, filed on Oct. 29, 2024, which claims priority to Chinese Patent Application No. 202311435972.9, filed on Oct. 31, 2023. The disclosures of the aforementioned applications are hereby incorporated by reference in their entireties.

### TECHNICAL FIELD

This application relates to the field of cable connection device technologies, and in particular, to a connector and an electronic device.

### BACKGROUND

When a cable is to be connected to a device, a connector needs to be disposed at one end of the cable to be connected, so that an electrical connection is formed between the cable and the device.

If the connector is exposed to a humid environment in rainy or snowy weather when used outdoors, there is a risk such as poor contact between the connector that is exposed to moisture or water and the cable. Therefore, the connector and the cable have already been designed as a moisture-proof and waterproof form for use. A conventional connector usually includes a waterproof component, which fits the cable to implement a waterproof function. During installation, a sealed connection between the cable and the connector is usually implemented by screwing. Due to long time consumption for many turns of screwing, construction personnel cannot ensure that the screwing is in position, resulting in waterproof failure. Therefore, a connector that is easy to install needs to be provided.

### SUMMARY

This application provides a connector and an electronic device. The connector is easy to install with a reliable waterproof effect.

According to a first aspect, this application provides a connector. The connector includes a sealing member, a first shell, a second shell, and a rotating member. The sealing member has a through hole for a cable to pass through, and the sealing member is fastened to the first shell. The second shell has an abutting surface that is disposed toward an outer periphery of the sealing member, and the abutting surface is at an included angle with an axis of the through hole. The rotating member is rotatably disposed on the second shell, and the rotating member is connected to the first shell and configured to cause the first shell and the second shell to move relative to each other in an axial direction of the through hole. When the rotating member rotates to a first position, the abutting surface abuts against the outer periphery of the sealing member, so that an inner wall of the through hole fits the cable in a sealed manner. In the foregoing embodiment, compared with a conventional operation of screwing a connecting nut to lock a connector, an operation of flipping the rotating member to lock the connector is more convenient and more accurate, to reduce cases of waterproof failure caused by insufficient shrinkage of the sealing member due to an insufficient quantity of turns of screwing of the connecting nut. In addition, the rotating member is flipped in position all at once, so that a connection of the connector is more reliable.

In an implementation, the connector further includes a clamping member, the clamping member includes a cylinder and a plurality of clamping jaws that are located at one end of the cylinder, and the plurality of clamping jaws are disposed at intervals around an axis of the cylinder. The cylinder is fastened to the first shell. The sealing member is fastened in a contour that is enclosed by the cylinder and the plurality of clamping jaws, and an outer peripheral surface of the sealing member fits an inner cylinder wall of the cylinder. The abutting surface is configured to abut against the outer periphery of the sealing member by abutting against the plurality of clamping jaws. The clamping member is squeezed by the abutting surface to shrink, so that the sealing member fits an outer wall of the cable, thereby improving a fitting effect of the sealing member.

In an implementation, the second shell includes a cylindrical portion, and the abutting surface is located on an inner cylinder wall of the cylindrical portion, so that the sealing member can be evenly stressed with a good shrinkage effect, thereby achieving a good waterproof effect.

In an implementation, the rotating member includes a first plate and a second plate that are disposed opposite to each other, the first plate has a first fastening hole, and the second plate has a second fastening hole. The second shell includes a first side wall and a second side wall that face away from each other, the first side wall has a first fixed shaft, the second side wall has a second fixed shaft, and an axis of the first fixed shaft coincides with an axis of the second fixed shaft. The first fixed shaft is disposed in the first fastening hole in a penetrating manner, and the second fixed shaft is disposed in the second fastening hole in a penetrating manner, to implement a rotary connection between the rotating member and the second shell.

In an implementation, the rotating member further includes a third plate that is connected between the first plate and the second plate, and the third plate can drive the first plate and the second plate to simultaneously rotate. The second shell includes a third side wall that is connected between the first side wall and the second side wall. The first plate and the second plate are separately connected to the third plate to form an accommodating slot. When the rotating member rotates to the first position, the third plate fits the third side wall and the second shell is located in the accommodating slot, thereby improving integrity of the connector.

In an implementation, the rotating member includes a sliding slot and a positioning slot that is located at one end of the sliding slot, the first shell includes a convex shaft, and the convex shaft is slidably disposed in the sliding slot in a penetrating manner. When the rotating member rotates to the first position, the convex shaft slides into the positioning slot, so that an operator can intuitively determine whether the rotating member rotates in position, thereby improving reliability of connector assembly.

In an implementation, there is a protrusion between the sliding slot and the positioning slot. The protrusion is configured to prevent the convex shaft from sliding out of the positioning slot, and reduce cases in which the rotating member is unlocked accidentally in adverse weather or due to misoperation.

In an implementation, when the rotating member rotates to the first position, the convex shaft, the positioning slot, and a center of rotation of the rotating member are located on a same straight line, and the straight line is parallel to the axis of the through hole, to form a self-locking structure. When there is adverse weather such as wind in an environment, a force may be generated to cause relative sliding between the first shell and the second shell. An action force is generated between the convex shaft and the positioning slot in the axial direction of the through hole. Because the convex shaft, the positioning slot, and the center of rotation of the rotating member are located on the same straight line, the action force between the convex shaft and the positioning slot does not drive the rotating member to rotate around the center of rotation, thereby achieving a self-locking effect.

In an implementation, the sliding slot is an arc-shaped slot and has a first end and a second end, the positioning slot is located at the second end, and a distance between the second end and the center of rotation of the rotating member is less than a distance between the first end and the center of rotation of the rotating member. Compared with the first end, the second end is closer to the center of rotation of the rotating member. When the rotating member is flipped for locking, the convex shaft slides from the first end to the second end of the sliding slot, to implement relative sliding between the first shell and the second shell, so that the abutting surface applies an effective action force to the sealing member.

In an implementation, the connector further includes a sealing ring, the first shell includes a fixed shell and an inner shell, the inner shell is fastened to the fixed shell, the fixed shell is configured to be fastened to a to-be-connected device, the sealing ring is located between the fixed shell and the inner shell, and the sealing ring fits both the fixed shell and the inner shell in a sealed manner, to reduce cases in which external water vapor enters the connector from between the fixed shell and the inner shell.

In an implementation, the connector further includes an electrically conductive terminal. The electrically conductive terminal is fastened to the first shell, and the electrically conductive terminal is configured to connect to a conductor in the cable, to implement an electrical connection between the cable and the to-be-connected device.

According to another aspect, an embodiment of this application further provides an electronic device. The electronic device includes a housing and the foregoing connector. The first shell is fastened to the housing, so that the connector can be effectively fastened to the housing of the electronic device. Because an operation of locking the foregoing connector is simple with a reliable waterproof effect, reliability of the electronic device can be effectively improved.

### BRIEF DESCRIPTION OF DRAWINGS

FIG. 1 is a diagram of a structure of a connector according to an embodiment of this application;

FIG. 2 is an exploded view of a connector according to an embodiment of this application;

FIG. 3 is an assembly diagram of a rotating member and a second shell according to an embodiment of this application;

FIG. 4 is an assembly diagram of a rotating member, a first shell, and a second shell according to an embodiment of this application;

FIG. 5 is a diagram of a structure of a rotating member according to another embodiment of this application;

FIG. 6 is a sectional view of a connector in an unlocked state according to an embodiment of this application;

FIG. 7 is a sectional view of a connector in a locked state according to an embodiment of this application;

FIG. 8 is an assembly diagram of a clamping member and a sealing member according to an embodiment of this application;

FIG. 9 is a sectional view of a second shell according to an embodiment of this application; and

FIG. 10 is a diagram of a structure of an electronic device according to an embodiment of this application.

### REFERENCE NUMERALS

1: first shell; 2: sealing member; 3: second shell; 4: rotating member; 100: cable; 321: abutting surface; 31: body; 311: first side wall; 312: second side wall; 3111: first fixed shaft; 313: third side wall; 41: first plate; 42: second plate; 43: third plate; 411: first fastening hole; 412: second fastening hole; 45: flipping piece; A: first end; B: second end; 13: convex shaft; 46: sliding slot; 461: positioning slot; 4611: protrusion; 11: fixed shell; 12: inner shell; 21: clamping member; 211: cylinder; 212: clamping jaw; 32: cylindrical portion; 322: cable hole; M: first direction; 2121: fixed tooth; 221: retaining slot; 5: electrically conductive terminal; 51: core; 52: cable clip; 24: plug post; 6: sealing ring; 231: first groove; 14: second groove; 101: housing.

### DESCRIPTION OF EMBODIMENTS

To make the objectives, technical solutions, and advantages of this application clearer, the following further describes this application in detail with reference to the accompanying drawings. However, example implementations can be implemented in a plurality of forms, and should not be construed as being limited to implementations described herein. Identical reference numerals in the accompanying drawings indicate identical or similar structures. Therefore, repeated description thereof is omitted. Words that express positions and directions in embodiments of this application are illustrated by using the accompanying drawings as an example. However, changes may be made as required, and all the changes fall within the protection scope of this application. The accompanying drawings in embodiments of this application are merely used to illustrate relative position relationships and do not represent an actual scale.

It should be noted that details are given in the following descriptions for ease of understanding this application. However, this application can be implemented in a plurality of manners different from those described herein, and a person skilled in the art may perform similar promotion without departing from the connotation of this application. Therefore, this application is not limited to the following disclosed implementations.

For ease of understanding a connector and an electronic device provided in embodiments of this application, the following first describes an application scenario thereof.

Outdoor devices usually include base stations, outdoor routers, and outdoor power supplies, for example, an active antenna unit (AAU) and an optical line terminal (OLT). The foregoing outdoor device usually needs to be connected to a cable by using a connector. Because the device is exposed to an outdoor environment, a waterproof component needs to be disposed in the connector to prevent water vapor from entering the connector and causing a short circuit in rainy or snowy weather. Currently, a waterproof joint is usually used as the waterproof component for the connector outdoors. The waterproof joint includes a connecting nut and a rubber ring. During installation, the connecting nut needs to be tightened to compress the rubber ring so that the rubber ring fits the cable, thereby implementing sealing and waterproofing. The outdoor device is usually installed at a high position. When installing the connector, construction personnel need to work at heights and screw the connecting nut manually or by using tools. The connecting nut needs to be screwed for many turns, and this takes a long construction time. In addition, in the foregoing environment, the construction personnel cannot ensure that the connecting nut is screwed in position, and a quantity of turns of screwing may be insufficient. Consequently, the waterproof joint does not clamp the cable tightly, resulting in waterproof failure. The waterproof failure may cause a short circuit, and reliability of a connection of the connector cannot be ensured. In addition, if the waterproof joint does not clamp the cable tightly, when the cable experiences an external force, the external force is directly transferred to a core of the cable and an electrically conductive structure of the connector, easily causing poor contact or even disconnection between the cable and the electrically conductive structure.

To resolve the foregoing problem, an embodiment of this application provides a connector. FIG. 1 is a diagram of a structure of a connector according to an embodiment of this application. As shown in FIG. 1, the connector includes a first shell 1, a sealing member 2, a second shell 3, and a rotating member 4. The sealing member 2 has a through hole for a cable to pass through. There is a gap between an outer wall of the cable 100 and a wall of the through hole, and water vapor may enter the connector due to the gap. The sealing member 2 is fastened to the first shell 1. The second shell 3 has an abutting surface 321 that is disposed toward an outer periphery of the sealing member 2, and the abutting surface 321 is at an included angle with an axis O of the through hole. The rotating member 4 is rotatably disposed on the second shell 3, and the rotating member 4 is connected to the first shell 1 and configured to cause the first shell 1 and the second shell 3 to move relative to each other in an axial direction of the through hole. When the rotating member 4 rotates to a first position, the abutting surface 321 abuts against the outer periphery of the sealing member 2, so that the sealing member 2 deforms and shrinks, and then the wall of the through hole fits the cable in a sealed manner, to prevent water vapor from entering the connector from a gap between the connector and the cable 100, thereby achieving a waterproof effect. When the rotating member 4 is at the first position, the connector is in a locked state. When the connector is being disassembled, the rotating member 4 is flipped in an opposite direction, so that the rotating member 4 rotates from the first position to a second position. When the rotating member 4 is at the second position, the connector is in an unlocked state. The first shell 1 and the second shell 3 slide relative to each other in opposite directions, so that the abutting surface 321 goes far away from the sealing member 2. The sealing member 2 stretches to return to an initial state, and releases the cable, so that the cable can be taken out.

It should be noted that the first position may be a specific position, or may be a range. A position to which the rotating member 4 rotates to cause the abutting surface 321 to abut against the sealing member 2 and to cause the wall of the hole of the sealing member 2 to fit the outer wall of the cable 100 may be understood as the first position. In addition, the second position means all positions other than the first position in a range of movement of the rotating member 4.

In the foregoing embodiment, when the connector is locked or unlocked, an operation of flipping the rotating member 4 is more convenient and more accurate than an operation of screwing a connecting nut in conventional technologies, to reduce cases of waterproof failure caused by insufficient shrinkage of the sealing member 2 due to an insufficient quantity of turns of screwing of the connecting nut, so that a connection of the connector is more reliable.

During selection of the sealing member 2, an elastic rubber ring may be used as the sealing member 2. The rubber ring shrinks and presses the cable tightly under a pressure from the abutting surface 321, with a good waterproof effect.

In the example shown in FIG. 1, only a simplified diagram of a structure of the connector is shown. In actual application, a structural type of the connector may be diversified.

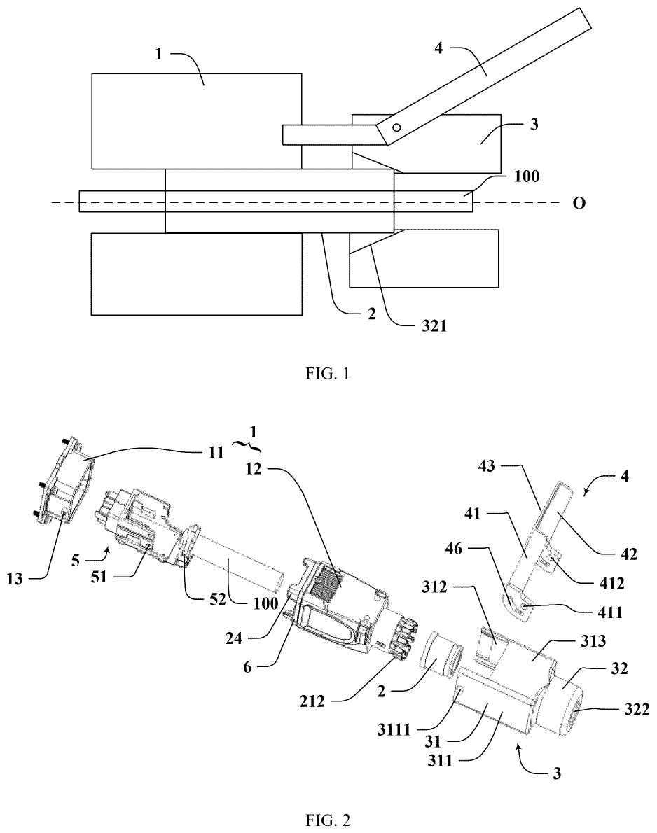

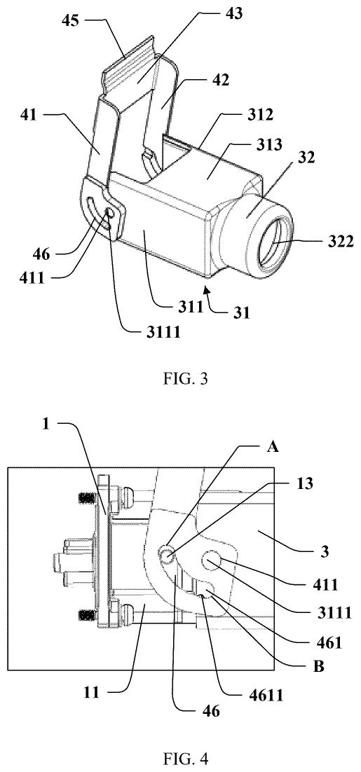

For example, refer to FIG. 2 and FIG. 3. FIG. 2 is an exploded view of a connector according to an embodiment of this application. FIG. 3 is an assembly diagram of a rotating member and a second shell according to an embodiment of this application. With reference to FIG. 2 and FIG. 3, in an embodiment, an overall appearance of the connector is approximately rectangular. The second shell 3 includes a body 31, and a cross section of the body 31 may also be rectangular. The body 31 includes a first side wall 311 and a second side wall 312 that face away from each other. The first side wall 311 has a first fixed shaft 3111, the second side wall 312 has a second fixed shaft (not shown in the figure), and an axis of the first fixed shaft 3111 coincides with an axis of the second fixed shaft. The rotating member 4 includes a first plate 41 and a second plate 42 that are disposed opposite to each other. The first plate 41 has a first fastening hole 411, and the second plate 42 has a second fastening hole 412. The first fixed shaft 3111 is disposed in the first fastening hole 411 in a penetrating manner, and the second fixed shaft is disposed in the second fastening hole 412 in a penetrating manner. The first fixed shaft 3111 and the second fixed shaft are a center of rotation of the rotating member 4, to implement a rotary connection between the rotating member 4 and the second shell 3.

To implement synchronous rotation of the first plate 41 and the second plate 42, the rotating member 4 further includes a third plate 43 that is connected between the first plate 41 and the second plate 42. The first plate 41, the second plate 42, and the third plate 43 are connected to each other to form an accommodating slot. The body 31 of the second shell 3 further includes a third side wall 313 that is connected between the first side wall 311 and the second side wall 312. When the rotating member 4 rotates to the first position, the rotating member 4 is snap-fit to the body 31, and the body 31 is located in the accommodating slot, that is, the third plate 43 fits the third side wall 313, thereby improving integrity of the connector. Alternatively, it may be understood that, when the rotating member 4 rotates to the first position, the third plate 43 almost fits the third side wall 313. When locking the connector, a worker may know whether the rotating member 4 rotates in position by judging whether the third plate 43 fits or almost fits the third side wall 313, to intuitively determine the locked state of the connector.

In an embodiment, a flipping piece 45 may be further disposed at an edge of a side that is of the third plate 43 and that is far away from the first fastening hole 411 and the second fastening hole 412. When the rotating member 4 is at the first position, the flipping piece 45 is at an acute included angle with the third side wall 313. In this way, the rotating member 4 can be easily raised, for the rotating member 4 to be flipped from the first position to the second position, causing the second shell 3 and the first shell 1 to slide relative to each other in opposite directions, so that the sealing member 2 loosens the cable 100.

In actual application, a manner of connection between the rotating member 4 and the first shell 1 may be diversified, so that the rotating member 4 can drive the first shell 1 to move relative to the second shell 3. For example, in an example provided in this application, relative movement between the first shell 1 and the second shell 3 is implemented in a manner of sliding connection between the rotating member 4 and the first shell 1.

FIG. 4 is an assembly diagram of a rotating member, a first shell, and a second shell according to an embodiment of this application. With reference to FIG. 2, FIG. 3, and FIG. 4, in an embodiment, the rotating member 4 includes a sliding slot 46. There may be two sliding slots 46. The two sliding slots 46 are respectively disposed on the first plate 41 and the second plate 42 of the rotating member 4. Disposing the sliding slots 46 on both the first plate 41 and the second plate 42 enables the rotating member 4 to be evenly stressed. The sliding slot 46 is an arc-shaped slot. The arc-shaped slot bends toward the first fastening hole 411 and the second fastening hole 412. The sliding slot 46 is located on a side that is of the first fastening hole 411 and the second fastening hole 412 and that is away from the second shell 3. The first shell 1 includes a convex shaft 13, and the convex shaft 13 is slidably disposed in the sliding slot 46 in a penetrating manner. The sliding slot 46 has a first end A and a second end B. When the rotating member 4 is at the second position, the convex shaft 13 is at the first end A. When the rotating member 4 rotates around the center of rotation to the first position, the convex shaft 13 slides from the first end A to the second end B along the sliding slot 46. When the rotating member 4 is at the first position, the convex shaft 13 is at the second end B. It is worth noting that, the sliding slot 46 may alternatively be disposed only on the first plate 41, or disposed only on the second plate 42, which can also implement an effect that the rotating member 4 drives the first shell 1 and the second shell 3 to slide relative to each other.

Refer to FIG. 4 again. In an embodiment, a positioning slot 461 is disposed at one end of the sliding slot 46, and the positioning slot 461 may be located at the second end B. When the rotating member 4 rotates to the first position, the convex shaft 13 slides into the positioning slot 461. In addition, in an example provided in this application, there is a protrusion 4611 between the sliding slot 46 and the positioning slot 461. The protrusion 4611 can block the convex shaft 13 to some extent, and can prevent the convex shaft 13 from accidentally sliding out of the positioning slot 461. The arc-shaped slot has two arc-shaped edges that are parallel to each other, and the protrusion 4611 may be located on the arc-shaped edge of the sliding slot 46.

Disposing the protrusion 4611 can improve both an effect of locking the connector and efficiency of the worker in locking the connector. When locking the connector, the worker rotates the rotating member 4. When the convex shaft 13 of the rotating member 4 crosses the protrusion 4611 and slides into the positioning slot 461, obvious resistance is generated, and the resistance is transferred to a hand, so that the worker can perceive whether the rotating member 4 is rotated in position. In addition, when the connector is in adverse weather such as wind in actual use, the rotating member 4 may experience a rotational force due to wind power. Under a position-limiting effect of the protrusion 4611, the convex shaft 13 of the rotating member 4 is not likely to slide out of the positioning slot 461, thereby effectively improving the effect of locking the connector.

In addition, in an example provided in this application, when the convex shaft 13 is in the positioning slot 461, the protrusion 4611 clamps the convex shaft 13 into the positioning slot 461. In this case, the convex shaft 13, the positioning slot 461, and the center of rotation of the rotating member 4 are located on a same straight line, and the straight line is parallel to an axis of the through hole, to form a self-locking structure. When there is adverse weather such as wind in an environment, a force may be generated to cause relative sliding between the first shell 1 and the second shell 3. An action force is generated between the convex shaft 13 and the positioning slot 461 in the axial direction of the through hole. Because the convex shaft 13, the positioning slot 461, and the center of rotation of the rotating member 4 are located on the same straight line, the action force between the convex shaft 13 and the positioning slot 461 does not drive the rotating member 4 to rotate around the center of rotation, thereby achieving a self-locking effect.

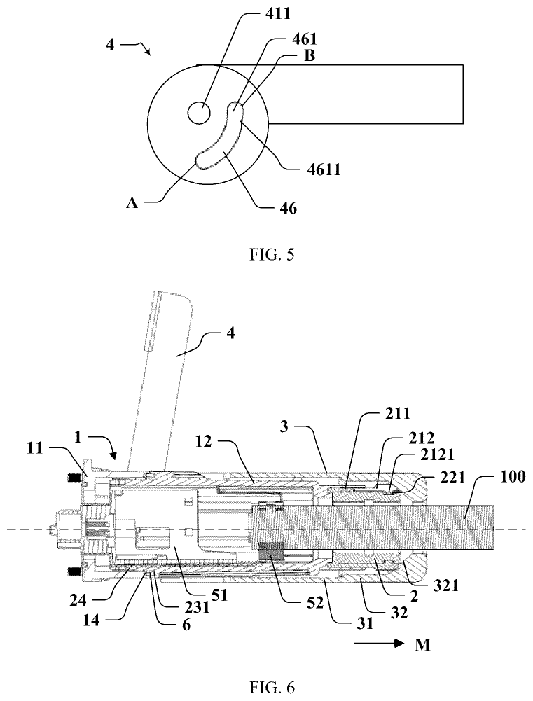

FIG. 5 is a diagram of a structure of a rotating member according to another embodiment of this application. With reference to FIG. 2 and FIG. 5, for an installation position of the rotating member 4, there is another installation mode. A position where the sliding slot 46 of the rotating member 4 is provided needs to be adjusted based on the installation position. In another embodiment, positions where the sliding slot 46 and the positioning slot 461 are provided on the rotating member 4 are contrary to those in the foregoing embodiment, that is, the sliding slot 46 and the positioning slot 461 are located on a side that is of the first fastening hole 411 and the second fastening hole 412 and that is close to the second shell 3. The rotating member 4 is in rotary connection to the first shell 1, and is connected to the second shell 3. The convex shaft 13 is disposed in the first fastening hole 411 and the second fastening hole 412 in a penetrating manner, to implement a rotary connection between the rotating member 4 and the first shell 1. The first fixed shaft 3111 and the second fixed shaft are disposed in the sliding slot 46 in a penetrating manner. In this embodiment, the convex shaft 13 is used as the center of rotation of the rotating member 4. When the rotating member 4 is at the first position, the first fixed shaft 3111 and the second fixed shaft slide into the positioning slot 461. In this case, the convex shaft 13, the positioning slot 461, and the first fixed shaft 3111 are located on a same straight line, and the straight line is parallel to the axis of the through hole of the sealing member 2.

In some of the foregoing embodiments, a distance a between the first end A of the sliding slot 46 and the center of rotation of the rotating member 4 and a distance b between the second end B and the center of rotation of the rotating member 4 satisfy a>b. In a rotational process of the rotating member 4, the first shell 1 and the second shell 3 move relative to each other, and a distance of relative movement between the first shell 1 and the second shell 3 is s, where s=a−b.

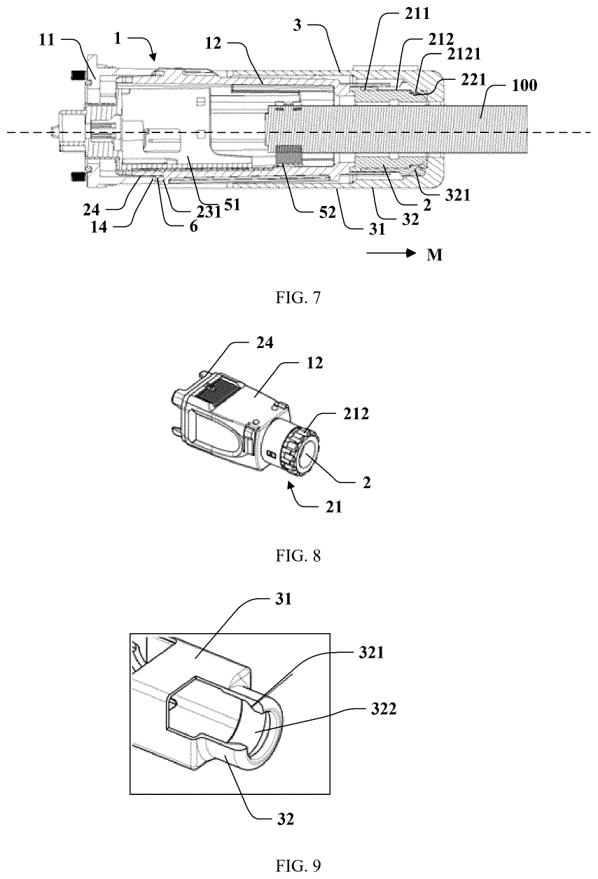

FIG. 6 is a sectional view of a connector in an unlocked state according to an embodiment of this application. FIG. 7 is a sectional view of a connector in a locked state according to an embodiment of this application. With reference to FIG. 2, FIG. 6, and FIG. 7, in an embodiment, the first shell 1 may include a fixed shell 11 and an inner shell 12. One end of the inner shell 12 is connected to the fixed shell 11, and the other end is connected to the sealing member 2. The fixed shell 11 may be a flange, and the flange is configured to fasten the connector to a to-be-connected device. The second shell 3 has an accommodating cavity, a shape of the inner shell 12 adapts to a shape of the accommodating cavity of the second shell 3, and the inner shell 12 is installed in the accommodating cavity in a sliding manner. The convex shaft 13 is located on two sides of the fixed shell 11. The second shell 3 and the fixed shell 11 are separately connected to the rotating member 4. After the fixed shell 11 is fastened to the to-be-connected device, the rotating member 4 is flipped to the first position and the rotating member 4 drives the second shell 3 to approach the fixed shell 11, so that the sealing member 2 shrinks and clamps the cable 100 tightly.

The fixed shell 11 is fastened to the inner shell 12, and the fixed shell 11 is connected to the to-be-connected device. Therefore, in a process in which the second shell 3 gradually approaches the fixed shell 11, the inner shell 12 remains in a stationary state. The second shell 3 moves relative to the inner shell 12, and the sealing member 2 connected to the inner shell 12 is squeezed by the abutting surface 321 of the second shell 3 to shrink, to clamp the cable 100 tightly. In this case, the sealing member 2 is in interference fit with the cable 100. The rotating member 4 is flipped, so that the rotating member 4 rotates from the first position to the second position, and the rotating member 4 drives the second shell 3 to go away from the fixed shell 11. In this case, the sealing member 2 in a shrinkage state is released and expands, so that the cable 100 is loosened from the sealing member 2, to facilitate removal of the cable 100.

FIG. 8 is an assembly diagram of a clamping member and a sealing member according to an embodiment of this application. With reference to FIG. 2, FIG. 6, FIG. 7, and FIG. 8, to enable the sealing member 2 to better shrink, in an embodiment, the connector may further include a clamping member 21. The clamping member 21 includes a cylinder 211 and a plurality of clamping jaws 212 that are located at one end of the cylinder 211. The plurality of clamping jaws 212 are disposed at intervals around an axis of the cylinder 211, and extend in an axial direction of the cylinder 211. The cylinder 211 is fastened to the inner shell 12 of the first shell 1, the sealing member 2 is fastened in a contour that is enclosed by the cylinder 211 and the plurality of clamping jaws 212, and an outer peripheral surface of the sealing member 2 fits an inner cylinder wall of the cylinder 211. The clamping member 21 forms a shrinking ring, and two adjacent clamping jaws 212 are spaced by a preset distance, so that the shrinking ring has a specific amount of compression. The clamping member 21 can shrink under an action of an external force, where the external force is an external force applied by the abutting surface 321.

Refer to FIG. 6 and FIG. 7 again. In an embodiment, a fixed tooth 2121 is disposed on a side that is of each clamping jaw 212 and that faces the sealing member 2, and a retaining slot 221 configured to clamp the fixed tooth 2121 is disposed on a side that is of the sealing member 2 and that faces the clamping jaw 212. The sealing member 2 is disposed in the clamping member 21, and the fixed tooth 2121 is clamped with the retaining slot 221, to avoid a case in which the sealing member 2 falls off due to relative sliding between the sealing member 2 and the inner shell 12 in an axial direction in a moving process of the inner shell 12.

FIG. 9 is a sectional view of a second shell according to an embodiment of this application. With reference to FIG. 2, FIG. 6, and FIG. 9, in an embodiment, the second shell 3 further includes a cylindrical portion 32. The cylindrical portion 32 is connected to the body 31, the cylindrical portion 32 is located at one end that is of the body 31 and that is away from the first shell 1, and the clamping member 21 and the sealing member 2 are both located in the cylindrical portion 32. The abutting surface 321 is located on an inner cylinder wall of the cylindrical portion 32, and the abutting surface 321 is at an acute included angle with the axis of the through hole. The abutting surface 321 is a conical surface, a diameter of the conical surface gradually decreases in a first direction M, and the first direction M is a direction in which the second shell 3 goes away from the first shell 1. An end of the sealing member 2 and an end of the clamping jaw 212 separately abut against the conical surface. In a process in which the rotating member 4 rotates to the first position, the sealing member 2 and the clamping jaw 212 slide along the conical surface. As the diameter of the conical surface gradually decreases, the sealing member 2 shrinks under a squeezing effect of the abutting surface 321 and the clamping member 21. The conical surface enables the sealing member 2 to shrink in two directions, for example, an axial direction and a radial direction, and enables it to be evenly stressed with a good shrinkage effect, thereby improving the waterproof effect.

The cylindrical portion 32 has a cable hole 322, and the cable hole 322 is configured for the cable 100 to pass through. There is a gap between the outer wall of the cable 100 and a wall of the cable hole 322. When the sealing member 2 and the clamping member 21 are being assembled, the sealing member 2 extends from the clamping member 21 by a preset distance in a direction toward the abutting surface 321. In other words, in the first direction M, a distance between the end of the sealing member 2 and the cable hole 322 is shorter than a distance between the end of the clamping jaw 212 and the cable hole 322. When the abutting surface 321 abuts against the sealing member 2 and the clamping member 21, the sealing member 2 can block not only a gap between the outer wall of the cable 100 and the through hole of the sealing member 2, but also the gap between the outer wall of the cable 100 and the wall of the cable hole 322, to prevent water vapor from entering the connector.

Refer to FIG. 2 and FIG. 7 again. In an embodiment, the connector further includes an electrically conductive terminal 5, the electrically conductive terminal 5 is fastened to the first shell 1, and the electrically conductive terminal 5 is configured to connect to a conductor (not shown in the figure) in the cable 100. The electrically conductive terminal 5 is installed in the inner shell 12. The electrically conductive terminal 5 includes a core 51 and a cable clip 52. The core 51 is configured to fasten the conductor in the cable 100, and the cable clip 52 is configured to clamp the cable 100. The cable clip 52 is fastened and installed on a side that is of the core 51 and that faces the clamping member 21. During assembly, the cable 100 is fastened by using the cable clip 52, and then an outer sheath of a portion of the cable 100 is stripped to expose the conductor. Next, after the conductor is fastened to the core 51, the electrically conductive terminal 5 is inserted into the inner shell 12.

Refer to FIG. 2 and FIG. 7 again. In an embodiment, a plug post 24 is provided on a side that is of the inner shell 12 and that faces the fixed shell 11. A cross section of the inner shell 12 may be rectangular, and there are four corners on an edge that is of the inner shell 12 and that faces the fixed shell 11. There may be four plug posts 24, and the four plug posts 24 are separately disposed on the edge of the side that is of the inner shell 12 and that faces the fixed shell 11, and are located at the four corners of the edge. During assembly, the plug post 24 is inserted into the fixed shell 11, so that the inner shell 12 is fastened to the fixed shell 11.

In another embodiment, a plug sleeve (not shown in the figure) may be used to take place of the plug post 24. The plug sleeve is tubular, and the plug sleeve is located on the edge of the side that is of the inner shell 12 and that faces the fixed shell 11. During assembly, the plug sleeve is inserted into the fixed shell 11.

With reference to FIG. 2 and FIG. 7, to improve sealing performance of the connector, in an embodiment, the connector further includes a sealing ring 6. The sealing ring 6 is located between the fixed shell 11 and the inner shell 12, and the sealing ring 6 fits both the fixed shell 11 and the inner shell 12 in a sealed manner. A first groove 231 is disposed on a surface of an end that is of the inner shell 12 and that faces the fixed shell 11, and the sealing ring 6 may be embedded in the first groove 231. When the rotating member 4 is at the first position, an end surface of the fixed shell 11 is in contact with the sealing ring 6. Alternatively, in another implementation, a second groove 14 is disposed on an end surface of an end that is of the fixed shell 11 and that faces the second shell 3; the sealing ring 6 is embedded in the first groove 231; and when the rotating member 4 is at the first position, a part of the sealing ring 6 is located in the second groove 14, with a better waterproof effect.

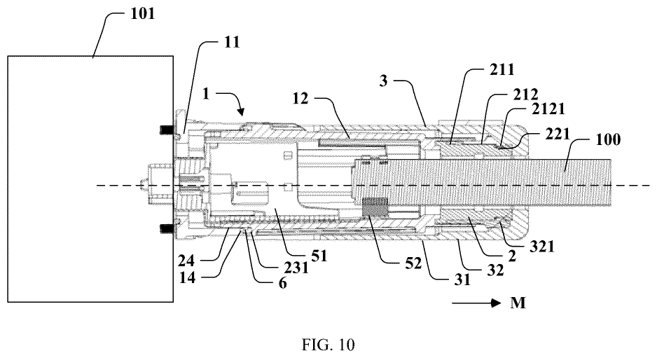

Based on a same inventive concept, an embodiment of this application further provides an electronic device. FIG. 10 is a diagram of a structure of an electronic device according to an embodiment of this application. As shown in FIG. 10, the electronic device includes a housing 101. The first shell 1 of the connector is fastened to the housing 101. The fixed shell 11 of the first shell 1 is fastened to the housing 101. Because an operation of locking the foregoing connector is simple with a reliable waterproof effect, reliability of the electronic device can be effectively improved.

Terms used in the foregoing embodiments are merely intended to describe example embodiments, but are not intended to limit this application. As used in the specification and appended claims of this application, the terms “one”, “a”, “the”, “the foregoing”, “this”, and “this one” in singular forms are intended to also include expressions such as “one or more”, unless otherwise indicated in the context explicitly.

Reference to “an embodiment”, “a specific embodiment”, or the like described in this specification means that one or more embodiments of this application include a feature, structure, or characteristic described with reference to the embodiment. The terms “include”, “including”, “have”, and their variants all mean “include but are not limited to”, unless otherwise emphasized in another manner.

1. A connector, comprising:
a sealing member;
a first shell;
a second shell; and
a rotating member,
wherein
the sealing member has a through hole for a cable to pass through, the through hole has a center axis extending along a first direction, and the sealing member is fastened to the first shell;
the second shell has an abutting surface facing an outer periphery of the sealing member, and the abutting surface is askew with respect to the center axis of the through hole,
the rotating member is coupled with the second shell and rotatable with respect to the second shell between a first position and a second position, the rotating member is connected to the first shell and movable with respect to the first shell, and the rotating member is coupled with the second shell and connected to the first shell such that, in a state in which the first shell is fixed in the first direction, moving the rotating member with respect to the second shell causes the second shell to move relative to the first shell along the first direction, and
moving the rotating member from the second position to the first position causes the second shell to move along the first direction such that the outer periphery of the sealing member contacts the abutting surface and the sealing member is sandwiched between the abutting surface and the cable.

2. The connector according to claim 1, further comprising:
a clamping member comprising a cylinder and a plurality of clamping jaws at one end of the cylinder,
wherein
the plurality of clamping jaws are axially spaced around an axis of the cylinder,
the cylinder is fastened to the first shell,
an outer peripheral surface of the sealing member fits within an inner cylinder wall of the cylinder, and
in the state in which the first shell is fixed in the first direction, moving the rotating member from the second position to the first position causes the second shell to move along the first direction such that the plurality of clamping jaws contact the abutting surface.

3. The connector according to claim 1, wherein the second shell comprises a cylindrical portion, and the abutting surface is on an inner cylinder wall of the cylindrical portion.

4. The connector according to claim 1, wherein
the rotating member comprises a first plate and a second plate, the first plate has a first fastening hole, the second plate has a second fastening hole, and the first plate is opposite to the second plate,
the second shell comprises a first side wall and a second side wall facing away from the first side wall, the second shell has a first fixed shaft protruding away from the first side wall, the second shell has a second fixed shaft protruding away from the second side wall,
the first fixed shaft is in the first fastening hole, and
the second fixed shaft is in the second fastening hole.

5. The connector according to claim 4, wherein
the rotating member further comprises a third plate between the first plate and the second plate,
the second shell comprises a third side wall between the first side wall and the second side wall, and
in the first position, the rotating member overlaps the second shell such that the third plate faces the third side wall.

6. The connector according to claim 1, wherein
the rotating member comprises a sliding slot and a positioning slot at one end of the sliding slot, the first shell comprises a convex shaft accommodated in the sliding slot, and
moving the rotating member to the first position causes the convex shaft to slide into the positioning slot.

7. The connector according to claim 6, wherein
the rotating member comprises a protrusion between the sliding slot and the positioning slot, and
the protrusion is configured to prevent the convex shaft from sliding out of the positioning slot.

8. The connector according to claim 6, wherein when the rotating member is in the first position, the convex shaft, the positioning slot, and a center of rotation of the rotating member are vertically aligned with respect to the center axis of the through hole.

9. The connector according to claim 6, wherein
the sliding slot is arc-shaped, and the sliding slot has a first end and a second end opposite the first end, and
the positioning slot is located at the second end of the sliding slot, and
a distance between the second end of the sliding slot and a center of rotation of the rotating member is less than a distance between the first end of the sliding slot and the center of rotation of the rotating member.

10. The connector according to claim 1, further comprising:
a sealing ring,
wherein the first shell comprises a fixed shell and an inner shell, the fixed shell is fastened to the inner shell, the sealing ring is between the fixed shell and the inner shell.

11. The connector according to claim 1, further comprising:
an electrically conductive terminal, wherein the electrically conductive terminal is fastened to the first shell, and the electrically conductive terminal is configured to be electrically coupled with a conductor in the cable.

12. An electronic device, comprising:
a housing; and
a connector, comprising:
a sealing member;
a first shell fastened to the housing;
a second shell; and
a rotating member,
wherein
the sealing member has a through hole for a cable to pass through, the through hole has a center axis extending along a first direction, and the sealing member is fastened to the first shell;
the second shell has an abutting surface facing an outer periphery of the sealing member, and the abutting surface is askew with respect to the center axis of the through hole,
the rotating member is coupled with the second shell and rotatable with respect to the second shell between a first position and a second position, the rotating member is connected to the first shell and movable with respect to the first shell, and the rotating member is coupled with the second shell and connected to the first shell such that moving the rotating member with respect to the second shell causes the second shell to move relative the first shell along the first direction, and
moving the rotating member from the second position to the first position causes the second shell to move along the first direction such that the outer periphery of the sealing member contacts the abutting surface and the sealing member is sandwiched between the abutting surface and the cable.

13. The electronic device according to claim 12, wherein
the connector further comprises a clamping member comprising a cylinder and a plurality of clamping jaws at one end of the cylinder,
the plurality of clamping jaws are axially spaced around an axis of the cylinder,
the cylinder is fastened to the first shell,
an outer peripheral surface of the sealing member fits within an inner cylinder wall of the cylinder, and
moving the rotating member from the second position to the first position causes the second shell to move along the first direction such that the plurality of clamping jaws contact the abutting surface.

14. The electronic device according to claim 12, wherein the second shell comprises a cylindrical portion, and the abutting surface is on an inner cylinder wall of the cylindrical portion.

15. The electronic device according to claim 12, wherein
the rotating member comprises a first plate and a second plate, the first plate has a first fastening hole, the second plate has a second fastening hole, and the first plate is opposite to the second plate,
the second shell comprises a first side wall and a second side wall facing away from the first side wall, the second shell has a first fixed shaft protruding away from the first side wall, the second shell has a second fixed shaft protruding away from the second side wall,
the first fixed shaft is in the first fastening hole, and
the second fixed shaft is in the second fastening hole.

16. The electronic device according to claim 15, wherein
the rotating member further comprises a third plate between the first plate and the second plate,
the second shell comprises a third side wall between the first side wall and the second side wall, and
in the first position, the rotating member overlaps the second shell such that the third plate faces the third side wall.

17. The electronic device according to claim 12, wherein
the rotating member comprises a sliding slot and a positioning slot at one end of the sliding slot, the first shell comprises a convex shaft accommodated in the sliding slot, and
moving the rotating member to the first position causes the convex shaft to slide into the positioning slot.

18. The electronic device according to claim 17, wherein
the rotating member comprises a protrusion between the sliding slot and the positioning slot, and
the protrusion is configured to prevent the convex shaft from sliding out of the positioning slot.

19. The electronic device according to claim 17, wherein when the rotating member is in the first position, the convex shaft, the positioning slot, and a center of rotation of the rotating member are vertically aligned with respect to the center axis of the through hole.

20. (canceled)

21. A connector, comprising:
a sealing member;
a first shell;
a second shell; and
a rotating member,
wherein
the sealing member has a through hole for a cable to pass through, the through hole has a center axis extending along a first direction, and the sealing member is fastened to the first shell;
the second shell has an abutting surface facing an outer periphery of the sealing member, and the abutting surface is askew with respect to the center axis of the through hole,
the rotating member is coupled with the first shell and rotatable with respect to the first shell between a first position and a second position, the rotating member is connected to the second shell and movable with respect to the second shell, and the rotating member is coupled with the first shell and connected to the second shell such that, in a state in which the first shell is fixed in the first direction, moving the rotating member with respect to the first shell causes the second shell to move relative to the first shell along the first direction, and
moving the rotating member from the second position to the first position causes the second shell to move along the first direction such that the outer periphery of the sealing member contacts the abutting surface and the sealing member is sandwiched between the abutting surface and the cable.
